(19) United States
(12) Patent Application Publication
(10) Pub. No.: US 2025/0272140 A1
(43) Pub. Date: Aug. 28, 2025

(54) INFORMATION HANDLING SYSTEM TO EXTEND AND SCALE A PLATFORM TELEMETRY FRAMEWORK TO A REMOTE COMPUTE DEVICE

(71) Applicant: DELL PRODUCTS L.P., Round Rock, TX (US)

(72) Inventors: Balasingh Samuel, Round Rock, TX (US); Farzad Khosrowpour, Pflugerville, TX (US)

(21) Appl. No.: 18/588,794

(22) Filed: Feb. 27, 2024

(51) Int. Cl. G06F 9/48

(52) U.S. Cl. CPC G06F 9/4856; G06F 9/4881

(57) ABSTRACT

An information handling system includes a memory to store a system trigger event. A processor executes first and second applications, and provides data to the first application via a first data lane and to the second application via a second data lane. The processor retrieves the system trigger event from the memory and determines whether the system trigger event has been detected. In response to the system trigger event being detected, the processor transfers execution of the first application from the information handling system to a remote compute device and creates a third data lane from the data to the first application being executed on the remote compute device. The processor provides the data to the first application being executed on the remote compute device.

### FIELD OF THE DISCLOSURE

The present disclosure generally relates to information handling systems, and more particularly relates to performing and scaling platform telemetry framework to a remote compute device.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a memory to store a system trigger event. A processor may execute first and second applications. The processor may provide data to the first application via a first data lane and to the second application via a second data lane. The processor may retrieve the system trigger event from the memory and determine whether the system trigger event has been detected. In response to the system trigger event being detected, the processor may transfer execution of the first application from the information handling system to a remote compute device and create a third data lane from the data to the first application being executed on the remote compute device. The processor may provide the data to the first application being executed on the remote compute device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a portion of a system including an information handling system and a remote compute device according to at least one embodiment of the present disclosure;

FIG. 2 is a flow diagram of a method for performing and scaling platform telemetry framework to a remote compute device according to at least one embodiment of the present disclosure; and

FIG. 3 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

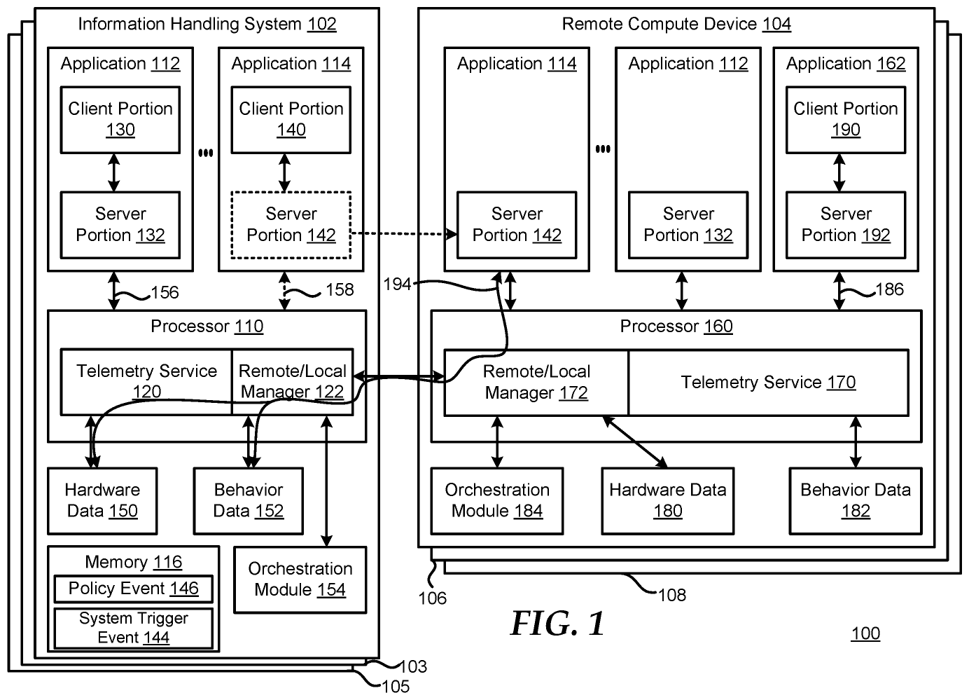

FIG. 1 illustrates a system 100 including an information handling system 102 and a remote compute device 104 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 102 includes a processor 110, multiple applications 112 and 114 to be executed by the processor or any other suitable processing component, and a memory 116. While two applications 112 and 114 are illustrated in FIG. 1, information handling system 102 may include any suitable number of applications to be executed within the information handling system. Processor 102 may execute a telemetry service 120 and a remote/local manager 122. In an example, remote/local manager 122 may be a part of telemetry service 120. Application 112 may include a client portion 130 and a server portion 132. Similarly, application 114 may include a client portion 140 and a server portion 142. Memory 116 may store data associated with information handling system 102 including, but not limited to, one or more system trigger events 144 and one or more policy events 146. Applications 112 and 114 may utilize and perform operations on data within information handling system 102, such as hardware data 150 and behavior data 152. Processor 120 may execute a data orchestration module 154 to determine whether operation of an application should be performed within information handling system 102 or remote compute device 104 as will be described herein.

Remote compute device 104 includes a processor 160 and an application 162 to be executed by the processor or any other suitable processing component. In certain examples, execution of one or more of applications 112 and 114 may be transferred from information handling system 102 to remote compute device 104 as will be described herein. While only a single application 162 is illustrated in FIG. 1, remote compute device 104 may include any suitable number of applications to be executed by processor 160 or other processing components within the remote compute device. Processor 160 may also execute a telemetry service 170 and a remote/local manager 172. In an example, remote/local manager 172 may be a part of telemetry service 170. Application 162 may include a client portion 190 and a server portion 192. Application 162 may utilize and perform operations on data within remote compute device 104, such as hardware data 180 and behavior data 182. Processor 160 may execute a data orchestration module 184.

In an example, remote compute device 104 may be any suitable device external to information handling system 102, such as an edge compute device, a dedicated compute server, a remote cloud server, or the like. In certain examples, system 100 may include any suitable number of information handling systems, such as information handling systems 103 and 105 illustrated in FIG. 1, and any suitable number of remote compute devices, such as remote compute devices 106 and 108 illustrated in FIG. 1, without varying from the scope of this disclosure. Information handling system 102 and remote compute device 104 may include additional components without varying from the scope of this disclosure.

During operation of information handling system 102, applications 112 and 114 may utilize hardware data 150 and behavior data 152 of the information handling system to perform different operations. For example, applications 112 and 114 may be characterized as intelligent software applications that perform complex tasks, make predictions, automate operations, or the like. In an example, applications 112 and 114 may utilize hardware data 150 and behavior data 152 to make decisions during the performance of any one of the operations stated above. In certain examples, processor 110 may execute telemetry service 120 to provide hardware data 150 and behavior data 152 to applications 112 and 114. Each of applications 112 and 114 may be a single entity or act in a client/server approach. For example, server portion 132 of application 112 may gather hardware data 150 and behavior data 152 via telemetry services 120 and provide the gathered data to client portion 130. Similarly, server portion 142 of application 114 may gather hardware data 150 and behavior data 152 via telemetry services 120 and provide the gathered data to client portion 140.

In certain examples, server portion 132 may perform different data analytics on hardware data 150 and behavior data 152. Client portion 130 of application 112 may serve as a user experience provider for a user of information handling system 102 and perform operations on hardware data 150 and behavior data 152. Similarly, server portion 142 may perform different data analytics on hardware data 150 and behavior data 152. Client portion 140 of application 114 may serve as a user experience provider for a user of information handling system 102 and perform operations on hardware data 150 and behavior data 152.

In an example, system 100 may be any suitable system, such as an information technology (IT) infrastructure, which may utilize a combination of endpoints, such as multiple information handling systems 102, and edge resources, such as multiple remote compute devices 104, to execute different workloads. In an example, the workloads, such as server portion 142 of application 114, may dynamically transition from information handling system 102 to remote compute device 104 or from the remote compute device to the information handling system to effectively optimize the system resources. The workload transitions may be based on any suitable factors, such as system health, latency, workload context, or the like. In previous information handling systems, the information handling systems and the remote compute devices may require separate data orchestration modules to route data between telemetry services and the application workloads. In these previous information handling systems, the transfer of data between the telemetry services and application workloads were not scalable and added both latency and complications.

Information handling system 102 and remote compute device 104 may be improved based on operations of processor 110 executing telemetry service 120 and processor 160 executing telemetry service 170. In particular, information handling system 102 may be improved by the transition of the execution of an application, such as application 114, from the information handling system to remote compute device 104. For example, processor 110, via coordination between remote/local manager 122 of telemetry service 120 and orchestration module 154, may automatically transfer the execution of application 112 or 114 to remote compute device 104 and re-route the corresponding data lane between hardware data 150 and behavior data 152 through telemetry service 170 of the remote compute device. In an example, information handling system 102 may be further improved by processor, via telemetry service 120, either transferring data to application 114 locally via a data lane 158 or remotely via data lane 194. In certain examples, the data lane transition from data lane 158 to data lane 194 may be transparent to application 114.

During operation of information handling system 102, any suitable number of applications, such as applications 112 and 114, may run on the information handling system. For example, processor 110 or another processing component may execute applications 112 and 114. In an example, processor 110, via telemetry service 120, may provide hardware data 150 and behavior data 152 to both applications 112 and 114. For example, telemetry service 120 may provide hardware data 150 and behavior data 152 to application 112 via data lane 156 and to application 114 via data lane 158. The operations of telemetry service 120 providing hardware data 150 and behavior data 152 to applications 112 and 114 being executed on information handling system 102 may be referred to herein as local data gathering operations. Thus, local gathering operations are performed when telemetry service 120 provides data from a source that is located on the same information handling system as the application utilizing the data. In certain examples, applications 112 and 114 may be instantiated on remote compute device 104 as illustrated in FIG. 1.

During operation of remote compute device 104, any suitable number of applications, such as application 162, may run on the remote compute device. For example, processor 160 or another processing component may execute application 162. In an example, processor 160, via telemetry service 170, may provide hardware data 180 and behavior data 182 to application 162 via data lane 186. In an example, server portion 192 may perform different data analytics on hardware data 180 and behavior data 182. Client portion 190 of application 162 may serve as a user experience provider for a user of remote compute device 104 and perform operations on hardware data 150 and behavior data 152.

In an example processor 110, via data orchestration module 154, may detect system trigger event 144, policy event 146, or the like. In an example processor 110, via data orchestration module 154, may retrieve system trigger event 144 and policy 146 from memory 116 so that the processor may monitor for the events. System trigger event 144 or policy event 146 may be any suitable event to cause the execution of server portion 132 in application 112 or server portion 142 in application 114 to be transferred to one of the remote compute devices 104, 106, and 108 in system 100, such as remote compute device 104. In an example system trigger event 144 may include, but is not limited to, a system health level, a detected latency of the data transfer, and a workload context. For example if the system health of information handling system 102 drops below a threshold level, processor 110, via data orchestration module 154, may determine that execution of application 114 should be transferred to remote compute device 104. In an example, if a workload on processor 110 is above a threshold level, processor 110, via data orchestration module 154, may determine that execution of application 114 should be transferred to remote compute device 104.

Based on this determination, remote/local manager 122 of telemetry service 120 may communicate with remote/local manager 172 of telemetry service 170 to perform the transfer of the execution of application 114 from information handling system 102 to remote compute device 104. The transition or transfer of execution of server portion 142 of application 114 from information handling system 102 to remote compute device 104 is illustrated in FIG. 1 by dashed arrow between the information handling system and the remote compute device. In an example, the communication between information handling system 102 and remote compute device 104 may be over any suitable network communication interface. In certain examples, the current state of server portion 142 of application 114 may be provided to processor 160, which in turn may initialize application 114 for execution on remote compute device 104.

In an example, application 114 may be a containerized application. In this example and based on the determination to transfer application 114 to remote compute device 104, remote/local manager 122 of telemetry service 120 may communicate with remote/local manager 172 of telemetry service 170 to perform the transfer of the execution of application 114 from information handling system 102 to remote compute device 104. The transition or transfer of execution of server portion 142 of application 114 from information handling system 102 to remote compute device 104 is illustrated in FIG. 1 by dashed arrow between the information handling system and the remote compute device. In an example, the communication between information handling system 102 and remote compute device 104 may be over any suitable network communication interface. In certain examples, the current state of the entire containerized application 114 may be provided to processor 160, which in turn may initialize application 114 for execution on remote compute device 104.

After the execution of application 114 is transferred to remote compute device 104, telemetry services 170 and 120 may communicate over a network to automatically create data lane 194. In an example, data lane 194 may be utilized to provide hardware data 150 and behavior data 152 on information handling system 102 to application 114 on remote compute device 104. In certain examples, data lane 194 may represent a remote data operation, such that telemetry service 170 may automatically gather hardware data 150 and behavior data 152 from information handling system 102. In certain examples, local/remote managers 122 and 172 may establish data lane 194 to ensure that telemetry service 170 gathers hardware data 150 and behavior data 152 from the correct end-point device, such as information handling system 102.

In an example, orchestration module 154 may monitor the conditions of information handling system 102 to determine whether application 114 may no longer needed to be executed on remote compute device 104. Similarly, orchestration module 184 may monitor the conditions of remote compute device 104 to determine whether application 114 may no longer be executed on the remote compute device. Based on the determination by based on processor 110, via orchestration module 154, or processor 160, via orchestration module 154, the execution of application 114 may be transferred back to information handling system 102.

In certain examples, remote/local manager 122 of telemetry service 120 may communicate with remote/local manager 172 of telemetry service 170 to perform the transfer of the execution of application 114 from remote compute device 104 to information handling system 102. After the execution of application 114 is transferred back to information handling system 102, telemetry service 120 may provide hardware data 150 and behavior data 152 to service portion 142 of application 114 via data lane 158. In certain examples, the current state of server portion 142 of application 114 may be provided to processor 110, which in turn may initialize application 114 for execution again on information handling system 102. In examples that application is a containerized application, the current state of the entire containerized application 114 may be provided to processor 110, which in turn may initialize application 114 for execution again on information handling system 102.

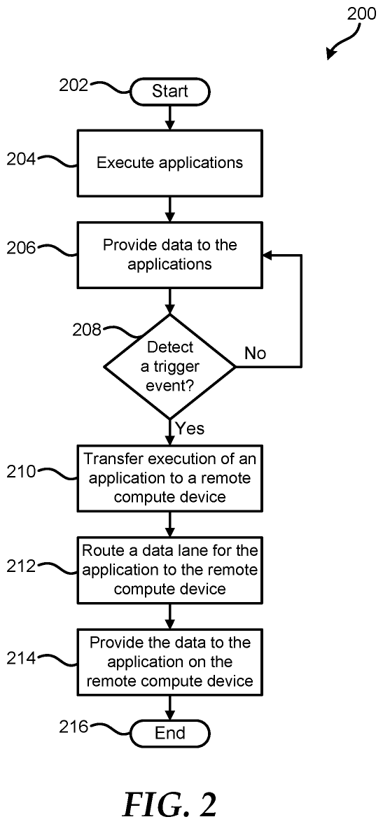

FIG. 2 is a flow diagram of a method 200 for performing and scaling platform telemetry framework to a remote compute device according to at least one embodiment of the present disclosure, starting at block 202. It will be readily appreciated that not every method step set forth in this flow diagram is always necessary, and that certain steps of the methods may be combined, performed simultaneously, in a different order, or perhaps omitted, without varying from the scope of the disclosure. FIG. 2 may be employed in whole, or in part, processor 110 of information handling system 102 and processor 160 of remote device 104 of FIG. 1, or any other type of controller, device, module, processor, or any combination thereof, operable to employ all, or portions of, the method of FIG. 2.

At block 204, one or more applications are executed in an information handling system. In an example, the applications may be characterized as intelligent software applications that perform complex tasks, make predictions, automate operations, or the like. At block 206, data is provided to the applications. In certain examples, the data may be provided by a telemetry service of a processor of the information handling system. The data may be any suitable data of the information handling system, such as hardware data, behavior data, or the like. In an example, the data may be provided to the applications via one or more data lanes created by the telemetry service.

At block 208, a determination is made whether a trigger event has been detected. In an example, system trigger event or policy event may be any suitable event to cause the execution of a server portion in an application to be transferred to a remote compute device. In certain examples, the system trigger event may include, but is not limited to, a system health level, a detected latency of the data transfer, and a workload context. If the trigger event has not been detected, the flow continues as described above with respect to block 206.

If the trigger event has been detected, the execution of the application is transferred to a remote compute device at block 210. In an example, a remote/local manager of a telemetry service in the information handling system may communicate with a remote/local manager of a telemetry service a remote compute device to perform the transfer of the execution of application from information handling system to remote compute device. In certain examples, the current state of the server portion of the application may be provided to a processor of the remote compute device, which in turn may initialize the application for execution on remote compute device. In an example, the application may be a containerized application. In this example, the current state of the entire containerized application may be provided to a processor of the remote compute device, which in turn may initialize the application for execution on remote compute device.

At block 212, a data lane for the application is routed to the remote compute device. In an example, the telemetry services of the information handling system and the remote compute device may communicate over a network to automatically create the data lane. In an example, the data lane may be utilized to provide the hardware data and behavior data on the information handling system to the application being executed on the remote compute device. In certain examples, the local/remote managers in the information handling system and the remote compute device may establish the data lane to ensure that the telemetry service of the remote compute device gathers the hardware data and behavior data from the correct end-point device. At block 214, the data is provided to the application on the remote compute device and the flow ends at block 216.

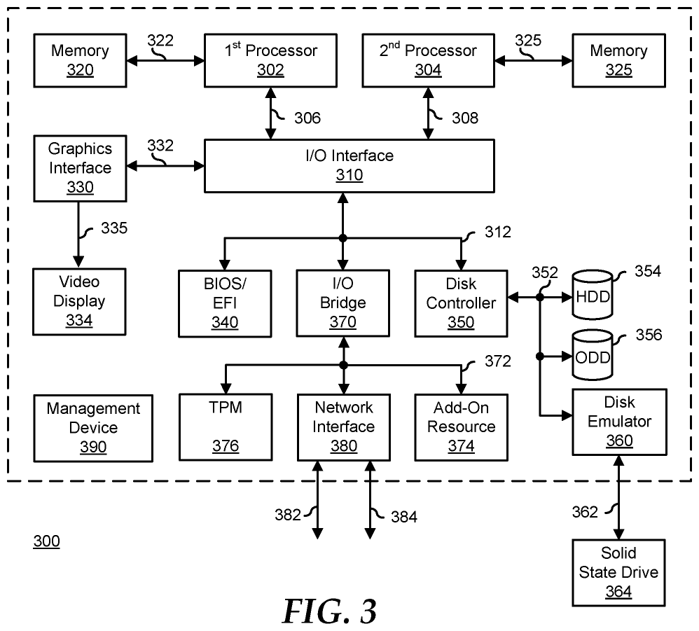

FIG. 3 shows a generalized embodiment of an information handling system 300 according to an embodiment of the present disclosure. Information handling system 300 may be substantially similar to information handling system 102 of FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332 and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 4394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312 or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300.

Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a memory to store a plurality of system trigger events; and
a processor to communicate with the memory, the processor to:
execute first and second applications;
provide data to the first application via a first data lane and to the second application via a second data lane;
retrieve the system trigger events from the memory;
determine whether one of the system trigger events has been detected; and
in response to the one of the system trigger events being detected, the processor further to:
transfer execution of the first application from the information handling system to a remote compute device;
create a third data lane from the data to the first application being executed on the remote compute device; and
provide the data to the first application being executed on the remote compute device over the third data lane.

2. The information handling system of claim 1, wherein the processor further to:
determine whether a condition exists to cause the execution of the first application to be transferred back to the information handling; and
in response to the condition existing, transfer the execution of the first application to the information handling system.

3. The information handling system of claim 2, wherein the processor further to: re-establish the first data lane between the data and the first application being executed on the information handling system.

4. The information handling system of claim 1, wherein the first application includes a client portion and a server portion.

5. The information handling system of claim 4, wherein the transfer of the execution of the first application from the information handling system to the remote compute device, the processor further to: transfer the server portion of the application to the remote compute device.

6. The information handling system of claim 1, wherein the processor further to: communicate with a second processor of the remote compute device to establish the third data lane.

7. The information handling system of claim 1, wherein the processor further to: execute a telemetry service to provide the data over the first data lane to the first application being executed in the information handling system.

8. The information handling system of claim 1, wherein the system trigger events includes a system health level, a detected latency of the data transfer, and a workload context.

9. A method comprising:
storing a plurality of system trigger events in a memory of an information handling system;
executing, by a processor of the information handling system, first and second applications;
providing, by the processor, data to the first application via a first data lane and to the second application via a second data lane;
retrieving the system trigger events from the memory;
determining whether one of the system trigger events has been detected; and
in response to the one of the system trigger events being detected:
transferring execution of the first application from the information handling system to a remote compute device;
creating a third data lane from the data to the first application being executed on the remote compute device; and
providing, by the processor, the data to the first application being executed on the remote compute device over the third data lane.

10. The method of claim 9, further comprising:
determining whether a condition exists to cause the execution of the first application to be transferred back to the information handling; and
in response to the condition existing, transferring the execution of the first application to the information handling system.

11. The method of claim 10, further comprising: re-establishing the first data lane between the data and the first application being executed on the information handling system.

12. The method of claim 9, wherein the first application includes a client portion and a server portion.

13. The method of claim 12, wherein the transferring of the execution of the first application from the information handling system to the remote compute device, the method further comprises: transferring the server portion of the application to the remote compute device.

14. The method of claim 9, further comprising: communicating with a second processor of the remote compute device to establish the third data lane.

15. The method of claim 9, further comprising: executing a telemetry service to provide the data over the first data lane to the first application being executed in the information handling system.

16. The method of claim 9, wherein the system trigger events includes a system health level, a detected latency of the data transfer, and a workload context.

17. A non-transitory computer-readable medium to store instructions that are executable to perform operations comprising:
executing first and second applications;
providing data to the first application via a first data lane and to the second application via a second data lane; and
if a system trigger event is detected, then:
transferring execution of the first application from the information handling system to a remote compute device;
creating a third data lane from the data to the first application being executed on the remote compute device; and
providing the data to the first application being executed on the remote compute device over the third data lane.

18. The non-transitory computer-readable medium of claim 9, the operations further comprising:
determining whether a condition exists to cause the execution of the first application to be transferred back to the information handling; and
in response to the condition existing, transferring the execution of the first application to the information handling system.

19. The non-transitory computer-readable medium of claim 10, the operations further comprising re-establishing the first data lane between the data and the first application being executed on the information handling system.

20. The non-transitory computer-readable medium of claim 9, the operations further comprising executing a telemetry service to provide the data over the first data lane to the first application being executed in the information handling system.
